(19) United States
(12) Patent Application Publication
(10) Pub. No.: US 2004/0140745 A1
(43) Pub. Date: Jul. 22, 2004

(54) Spark plug

(76) Inventor: Klaus Hrastnik, Stuttgart (DE)

Correspondence Address: KENYON & KENYON, ONE BROADWAY, NEW YORK, NY, 10004, US

(21) Appl. No.: 10/712,552

(22) Filed: Nov. 13, 2003

(30) Foreign Application Priority Data
Nov. 13, 2002 (DE) 10252736.9-13

(51) Int. Cl. H01T 13/39; H01T 13/00

(52) U.S. Cl. 313/141; 313/118

(57) ABSTRACT

A spark plug, which has an electrode, an electrode segment being provided at the one end segment of the electrode. The electrode segment has an alloy containing copper or an alloy containing platinum and rhodium.

### BACKGROUND INFORMATION

A spark plug is described in German Patent Application No. 100 15 642, for example. The spark plug has a middle electrode and a ground electrode between which a spark gap is formed by applying a voltage. The electrodes have an electrode base body to which an electrode segment that forms a highly erosion resistant region is affixed. The electrode base body is essentially made of nickel and may contain a heat-conducting copper core. The electrode segment is made of an alloy containing the elements iridium and nickel. The electrode segment is applied to the electrode base body via laser welding, resistance welding, or soldering.

In the case of such a spark plug, it is disadvantageous that during application in particular when welding the electrode segment to the electrode base body or during use in an engine, high thermomechanical stresses occur between the electrode segment and the electrode base body.

### SUMMARY OF THE INVENTION

The spark plug according to the present invention has the advantage that the material of the electrode segment was selected such that only minimal thermomechanical stresses occur between the electrode segment and the electrode base body and that the electrode segment has a particularly high resistance to wear. In addition, the reduction in the amount of precious metal results in a cost savings.

Thermomechanical stresses may be minimized when the materials to be joined have similar coefficients of thermal expansion and low elasticity modulus. The compositions according to the present invention allow an optimal adaptation of the material of the electrode segment to the material of the electrode base body.

Particularly minimal thermomechanical stresses result when the electrode segment has platinum in a proportion of 60 to 99 mass percent and copper in a proportion of 1 to 40 mass percent, or when the electrode segment has platinum in a proportion of 30 to 89 mass percent, copper in a proportion of 1 to 40 mass percent, and rhodium in a proportion of 10 to 30 mass percent, or when the electrode segment has platinum in a proportion of 30 to 98 mass percent, copper in a proportion of 1 to 40 mass percent, and iridium in a proportion of 1 to 30 mass percent. Also particularly suitable is an electrode segment having platinum in a proportion of 70 to 95 mass percent and rhodium in a proportion of 5 to 30 mass percent, or having platinum in a proportion of 30 to 94 mass percent, rhodium in a proportion of 5 to 30 mass percent, and nickel in a proportion of 1 to 40 mass percent, or having platinum in a proportion of 30 to 94 mass percent, a rhodium in a proportion of 5 to 30 mass percent, and iridium in a proportion of 1 to 40 mass percent.

The electrode segment advantageously additionally contains a metal or oxide or a plurality of metals or oxides from the group of yttrium, zircon, hafnium, titanium, tantalum, wolfram, osmium, ruthenium, gold, silver, and palladium, in particular each in a proportion of up to one mass percent. This measure increases the mechanical stability of the alloy of the electrode segment especially at high temperatures.

### BRIEF DESCRIPTION OF THE DRAWINGS

FIGS. 1a and 1b show a side view of a first and a second embodiment of a segment of a spark plug of the present invention on the combustion chamber side.

FIGS. 2a through 2d show a cross section of an end of a middle electrode of the spark plug of the present invention on the combustion chamber side.

FIGS. 3a through 3c show a cross section of an end of a ground electrode of the spark plug of the present invention on the combustion chamber side.

FIGS. 4a through 4c show a cross section of further examples of the combustion chamber end of a middle electrode of the spark plug of the present invention.

FIGS. 5a through 5d show a cross section of further examples of the end of a ground electrode of the spark plug on the combustion chamber side.

FIG. 6 shows a diagram in which wear volume V of a spark plug is plotted for two middle electrodes having different compositions as a function of operating time t.

### DETAILED DESCRIPTION

The basic construction and the operating principle of a spark plug is sufficiently known from the related art and can be taken, for example, from “Bosch-technischen Unterrichtung—Zündkerzen” (Bosch Technical Information—Spark Plugs), Robert Bosch GmbH 1985. FIG. 1a and FIG. 1b schematically show a side view of the end of a spark plug 10 on the combustion chamber side as a first and second embodiment of the present invention. The spark plug has a metallic, tubular housing 23, which is essentially radially symmetric. A coaxially running insulator 24 is positioned in a central bore along the symmetry axis of metallic housing 23. A middle electrode 21, which protrudes at the end of insulator 24 on the combustion chamber side from the bore in the first and second embodiment, is positioned in a central bore running along the longitudinal axis of insulator 24, at the end on the combustion chamber side. In a further embodiment (not shown), middle electrode 21 may also be positioned such that it does not protrude from the bore of insulator 24.

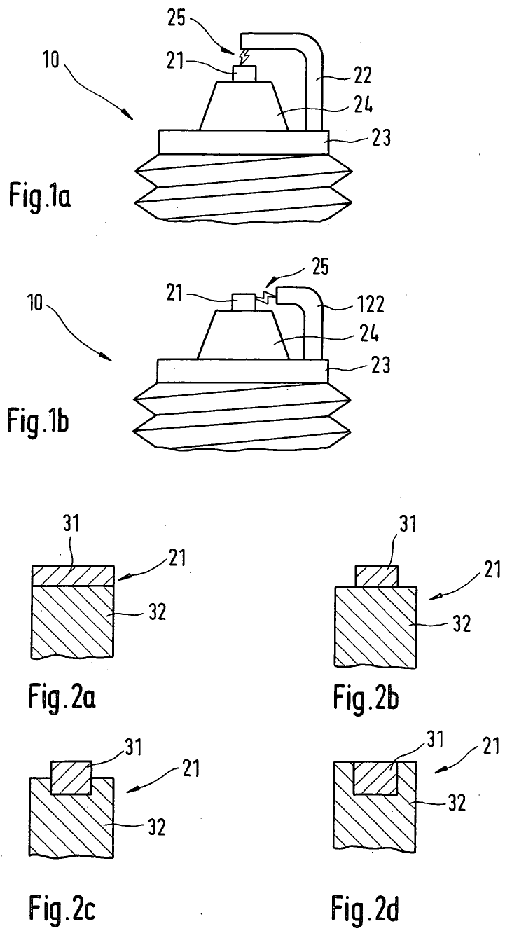

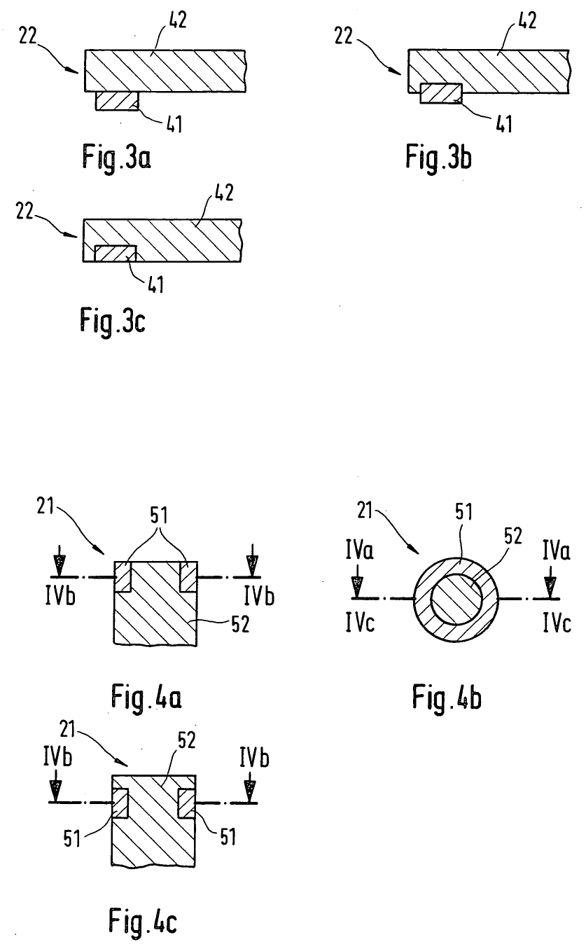

Situated at the end of middle electrode 21 away from the combustion chamber in the bore of insulator 24 (not shown) is an electroconductive glass melt that connects middle electrode 21 with the terminal stud (not shown) that is also situated in the central bore of the insulator. Furthermore, at least one ground electrode 22, 122 is positioned at the end of the metallic housing on the combustion chamber side. Ground electrode 22, 122 first extends starting from housing 23 parallel to the symmetry axis of housing 23 and then bends at a right angle to the direction of the symmetry axis of housing 23. The electrical energy reaching the end of spark plug 10 on the combustion chamber side via the terminal stud, the electroconductive glass melt, and middle electrode 21 then causes a spark along spark gap 25 between middle electrode 21 and ground electrode 22, 122 to sparkover, the spark igniting the air-fuel mixture located in the combustion chamber. Different embodiments of middle electrode 21 are shown in greater detail in FIGS. 2a through 2d and in FIGS. 4a through 4c. Different embodiments of ground electrode 22, 122 are shown in greater detail in FIGS. 3a through 3c and in FIGS. 4a through 4d.

The first embodiment according to FIG. 1a and the second embodiment according to FIG. 1b differ in the configuration of ground electrode 22, 122. In the first embodiment, ground electrode 22 is configured as a so-called top electrode that extends over the end face of middle electrode 21. In the case of ground electrode 22 configured as a top electrode, spark gap 25 lies in the region of the symmetry axis of housing 23 and insulator 24 and extends between the end face of middle electrode 21 and the end segment of ground electrode 22. In the second embodiment, ground electrode 122 does not extend to the symmetry axis of housing 23. The end segment of ground electrode 122 facing middle electrode 21 is positioned laterally next to middle electrode 21 and points at the lateral surface of middle electrode 21. As a result ground electrode 122 does not extend or extends only minimally beyond the end face of middle electrode 21. The spark gap of the second embodiment forms accordingly between the lateral surface of middle electrode 21 and the end face of ground electrode 122.

FIGS. 2a through 2d show a cross section of different embodiments of the ends of middle electrode 21 on the combustion chamber side. These embodiments are particularly suitable for a spark plug according to the first embodiment. Middle electrode 21 has an electrode base body 32, an electrode segment 31 being situated at the electrode base body end on the combustion chamber side. Electrode segment 31 is distinguished by a high resistance to spark erosion and corrosion so that a long functional life of the spark plug is ensured. In this instance, Electrode segment 31 forms an end of spark gap 25 so that the spark oversparks directly in the region of electrode segment 31 of middle electrode 21.

The different embodiments of FIGS. 2a through 2d differ in the positioning of electrode segment 31 on electrode base body 32. In FIG. 2a, electrode segment 31 completely covers the end face of electrode base body 32 facing the combustion chamber so that electrode segment 31 and electrode base body 32 have the same diameter at least in the transition region between electrode segment 31 and electrode base body 32. In FIG. 2b, cylindrical electrode segment 31 is positioned on the center of the end face of electrode base body 32, the diameter of electrode segment 31 being less than the diameter of electrode base body 32. In the case of middle electrode 21 according to FIG. 2c, electrode region 31 protrudes beyond the end face of electrode base body 32 on the spark gap side and into electrode base body 32. In FIG. 2d, electrode segment 31 extends into electrode base body 32, the end face of electrode segment 31 and electrode base body 32 facing the spark gap lying in one plane.

FIGS. 3a and 3c show different embodiments of the end segments of ground electrode 22 on the combustion chamber side that are particularly suited for the embodiment of the invention according to FIG. 1a. Ground electrode 22 has an electrode base body 42, an electrode segment 41 being provided on the side of the electrode base body facing middle electrode 21. The embodiments according to FIGS. 3a through 3c differ in the positioning of electrode segment 41 on electrode base body 42. In FIG. 3a, electrode segment 41 is provided outside on electrode base body 42, while in FIG. 3c electrode segment 41 is situated in a cutout in electrode base body 42 and does not protrude beyond the lateral surface of the electrode base body. In FIG. 3b, electrode segment 41 is situated as in FIG. 3c in a cutout in the electrode base body, but protrudes (as in FIG. 3a) out of electrode base body 42.

FIGS. 4a through 4c show a cross section of two further embodiments of the ends of middle electrode 21 on the combustion chamber side. These embodiments are particularly suited for a spark plug 10 according to the second embodiment. Middle electrode 21 has an electrode base body 52 on which an electrode segment 51, which has a high resistance to spark erosion and corrosion, is situated. Electrode segment 51 has a hollow cylindrical shape and is situated in a cutout in electrode base body 52. As a result, electrode segment 51 forms a segment of the lateral surface of middle electrode 21. The two embodiments according to FIGS. 4a and 4c differ in that, in FIG. 4a, electrode segment 51 extends to the end face of middle electrode 21, while in FIG. 4c, the cutout in middle electrode 21, in which electrode segment 51 is situated, does not extend to the end face of middle electrode 21. Further embodiments (not shown) of the present invention differ from the embodiments according to FIGS. 4a through 4c in that electrode segment 51 protrudes from the lateral surface of electrode base body 52, so that the diameter of electrode segment 51 is greater than the diameter of electrode base body 52.

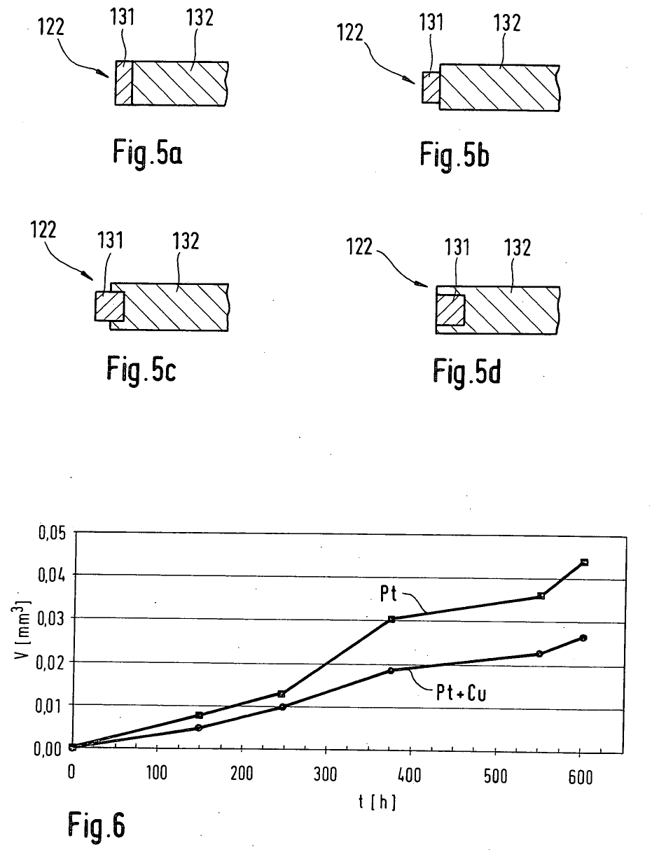

FIGS. 5a through 5d show further embodiments of ground electrode 122, which is particularly suited for the embodiment of the present invention according to FIG. 1b. Ground electrode 122 includes an electrode base body 132 on which an electrode segment 131, which has a high resistance to spark erosion and corrosion, is situated. The embodiments according to FIGS. 5a through 5d correspond in terms of the geometric configuration to the embodiments according to FIGS. 2a through 2d, so that a more detailed description is not necessary.

Electrode base body 32, 52 of middle electrode 21 as well as of electrode base body 42, 132 of ground electrode 22, 122 is made largely of nickel or a nickel alloy and usually contains a copper core that ensures effective heat conduction.

Electrode segment 31, 41, 51, 131 is positioned on electrode base body 32, 42, 52, 132 as a plate, pin, or flattened sphere via laser welding. Also suitable for joining electrode segment 31, 41, 51, 131 and electrode base body 32, 42, 52, 132 is diffusion welding or resistance welding. When welding electrode segment 31, 41, 51, 131 to electrode base body 32, 42, 52, 132, high temperatures occur and may result in high thermomechanical stresses in the materials. Also during use in an engine, high temperatures of up to 1000 degrees Celsius occur and may quickly cool to 400 degree Celsius. This results in thermomechanical stresses that are proportional to the difference of the coefficients of thermal expansion and the absolute value of the elasticity modulus (E modulus) of the materials of electrode segment 31, 41, 51, 131 and of electrode base body 32, 42, 52, 132.

In the following embodiments of the materials of electrode segment 31, 41, 51, 131, the material composition is selected such that only minimal thermomechanical stresses occur.

First composition of the material of electrode segment 31, 41, 51, 131:

Platinum: 96 mass percent

Copper: 4 mass percent

Second composition of the material of electrode segment 31, 41, 51, 131:

Platinum: 80 mass percent

Copper: 10 mass percent

Rhodium: 10 mass percent

Third composition of the material of electrode segment 31, 41, 51, 131:

Platinum: 70 mass percent

Copper: 10 mass percent

Iridium: 20 mass percent

Fourth composition of the material of electrode segment 31, 41, 51, 131:

Platinum: 85 mass percent

Rhodium: 15 mass percent

Fifth composition of the material of electrode segment 31, 41, 51, 131:

Platinum: 65 mass percent

Rhodium: 15 mass percent

Iridium: 20 mass percent

Sixth composition of the material of electrode segment 31, 41, 51, 131:

Platinum: 65 mass percent

Rhodium: 15 mass percent

Nickel: 20 mass percent

In FIG. 6, for an electrode segment 31, 41, 51, 131 of platinum (Pt) and for an electrode segment 31, 41, 51, 131 of platinum in a proportion of 96 mass percent and copper in a proportion of 4 mass percent (Pt+Cu), wear volume V is plotted in mm³ as a function of operating duration t in hours. This shows that electrode segment 31, 41, 51, 131 having a composition of the first embodiment (Pt+Cu) experiences significantly less wear than an electrode segment 31, 41, 51, 131 of pure platinum.

Electrode segment 31, 41, 51, 131 may include, in addition to the indicated materials, a metal or oxide or a plurality of metals or oxides from the group of yttrium, zircon, hafnium, titanium, tantalum, wolfram, osmium, ruthenium, gold, silver, and palladium, each in a proportion of up to one mass percent.

What is claimed is:

1. A spark plug comprising:
an electrode, the electrode including an electrode segment situated at one end segment of the electrode, the electrode segment including an alloy containing copper.

2. The spark plug according to claim 1, wherein the alloy of the electrode segment contains platinum.

3. The spark plug according to claim 1, wherein the electrode has platinum in a proportion of 60 to 99 mass percent and copper in a proportion of 1 to 40 mass percent.

4. The spark plug according to claim 1, wherein the electrode segment contains at least one of rhodium and iridium.

5. The spark plug according to claim 4, wherein the electrode segment has platinum in a proportion of 30 to 89 mass percent, copper in a proportion of 1 to 40 mass percent, and rhodium in a proportion of 10 to 30 mass percent.

6. The spark plug according to claim 4, wherein the electrode segment has platinum in a proportion of 30 to 98 mass percent, copper in a proportion of 1 to 40 mass percent, and iridium in a proportion of 1 to 30 mass percent.

7. A spark plug comprising:
an electrode, the electrode including an electrode segment situated at one end segment of the electrode, the electrode segment including an alloy containing platinum and rhodium.

8. The spark plug according claim 7, wherein the electrode segment includes platinum in a proportion of 70 to 95 mass percent and rhodium in a proportion of 5 to 30 mass percent.

9. The spark plug according to claim 7, wherein the electrode segment contains at least one of iridium and nickel.

10. The spark plug according to claim 9, wherein the electrode segment includes platinum in a proportion of 30 to 94 mass percent, rhodium in a proportion of 5 to 30 mass percent, and iridium in a proportion of 1 to 40 mass percent.

11. The spark plug according to claim 9, wherein the electrode segment includes platinum in a proportion of 30 to 94 mass percent, rhodium in a proportion of 5 to 30 mass percent, and nickel in a proportion of 1 to 40 mass percent.

12. The spark plug according to claim 7, wherein the electrode segment contains at least one metal or at least one oxide selected from the group of yttrium, zircon, hafnium, titanium, tantalum, wolfram, osmium, ruthenium, gold, silver, and palladium, each in a proportion of up to one mass percent.

13. The spark plug according to claim 7, wherein the electrode includes a first electrode and a second electrode, and wherein a spark oversparks between the first electrode and the second electrode along a spark gap in response to application of a voltage, the spark gap leading to the electrode segment of the electrode.

14. The spark plug according to claim 7, wherein the electrode further includes an electrode base body, the electrode segment being situated on the electrode base body via laser welding, the electrode base body being composed substantially of nickel, the electrode base body having a copper core.

15. The spark plug according to claim 7, wherein the electrode is a middle electrode, and further comprising at least one ground electrode, an insulator and a housing, and wherein the middle electrode is regionally insulated by the insulator from the housing, and the at least one ground electrode is affixed to the housing.
